(19) United States
(12) Patent Application Publication
(10) Pub. No.: US 2020/0256888 A1
(43) Pub. Date: Aug. 13, 2020

(54) ACOUSTIC AIR DATA SYSTEM

(71) Applicant: Rosemount Aerospace Inc., Burnsville, MN (US)

(72) Inventors: Todd Anthony Ell, Savage, MN (US); Richard Hull, Kissimmee, FL (US)

(21) Appl. No.: 16/271,021

(22) Filed: Feb. 8, 2019

(51) Int. Cl. G01P 5/24; G01C 23/00

(52) U.S. Cl. CPC G01P 5/245; G01C 23/00

(57) ABSTRACT

An acoustic air data sensing system includes an acoustic transmitter and a plurality of acoustic receivers. The acoustic transmitter is located to transmit an acoustic signal into airflow about an exterior of a vehicle. Each of the acoustic receivers is located at a respective angle from a wind angle reference line and a respective distance from the acoustic transmitter. Planar components of a velocity of the airflow are determined based on signal velocities of the acoustic signal to each of the plurality of acoustic receivers and the respective angles of the acoustic receivers from the wind angle reference line. Based on the planar components, the acoustic transmitter determines one or more of true airspeed and relative wind angle of the airflow about the exterior of the vehicle. The acoustic transmitter outputs the one or more of the true airspeed and the relative wind angle for operational control of the vehicle.

### BACKGROUND

This disclosure relates generally to air data systems, and more particularly to acoustic air data systems.

Certain vehicles, such as aircraft, missiles, high speed ground vehicles, or other vehicles have incorporated air data systems that calculate air data outputs based on measured parameters collected from various sensors positioned about the vehicle. For instance, many aircraft air data systems utilize pneumatic air data probes (e.g., pitot and/or pitot-static probes) that measure pneumatic pressure of oncoming airflow about the aircraft exterior to generate aircraft air data outputs, such as true airspeed, calibrated airspeed, Mach number, altitude, angle of attack, angle of sideslip, or other air data parameters. Traditional angle of attack sensors typically work by aligning a rotating vane with local airflow about the aircraft exterior. The angle of the rotating vane is compared to a reference line of the aircraft, such as a horizontal reference line of the aircraft aligned with, e.g., a chord of a wind of the aircraft, to produce a measured angle of attack.

Traditional pneumatic and rotating vane sensors, however, can be susceptible to failure modes caused by icing and/or particulates within the airflow (e.g., volcanic ash). Ice buildup, for example, can prevent or inhibit rotation of an angle of attack vane, thereby decreasing accuracy of angle of attack measurements. Icing conditions and/or particulate buildup within a pneumatic pitot and/or pitot-static probe can similarly degrade performance of the pneumatic probe to accurately measure pressures of the oncoming airflow, thereby negatively impacting performance of the air data system.

### SUMMARY

In one example, an acoustic air data sensing system includes an acoustic transmitter, a plurality of acoustic receivers, and control circuitry. The acoustic transmitter is located to transmit an acoustic signal into airflow about an exterior of a vehicle. Each of the plurality of acoustic receivers is located at a respective angle from a wind angle reference line and a respective distance from the acoustic transmitter to receive the acoustic signal transmitted by the acoustic transmitter. The control circuitry is configured to determine respective times of flight of the acoustic signal from the acoustic transmitter to each of the plurality of acoustic receivers, and determine signal velocities of the acoustic signal to each of the plurality of acoustic receivers based on the respective distances and respective times of flight of the acoustic signal from the acoustic transmitter to the acoustic receivers. The control circuitry is further configured to determine planar components of a velocity of the airflow about the exterior of the vehicle based on the signal velocities and the respective angles of the acoustic receivers from the wind angle reference line. The control circuitry is further configured to determine a speed of sound in the airflow about the exterior of the vehicle based on the signal velocities and the respective angles of the acoustic receivers from the wind angle reference line, determine one or more of true airspeed and relative wind angle of the airflow about the exterior of the vehicle based on the planar components of the velocity of the airflow about the exterior of the vehicle, and output the one or more of the true airspeed and the relative wind angle for operational control of the vehicle.

In another example, a method includes transmitting, by an acoustic transmitter of an acoustic air data sensor located on a vehicle, an acoustic signal into airflow about an exterior of the vehicle. The method further includes receiving the acoustic signal at a plurality of acoustic receivers of the acoustic air data sensor. Each of the plurality of acoustic receivers is located at a respective angle from a wind angle reference line and a respective distance from the acoustic transmitter. The method further includes determining respective times of flight of the acoustic signal from the acoustic transmitter to each of the plurality of acoustic receivers, determining signal velocities of the acoustic signal to each of the plurality of acoustic receivers based on the respective distances and respective times of flight of the acoustic signal from the acoustic transmitter to the acoustic receivers, determining planar components of a velocity of the airflow about the exterior of the vehicle based on the signal velocities and the respective angles of the acoustic receivers from the wind angle reference line, and determining a speed of sound in the airflow about the exterior of the vehicle based on the signal velocities and the respective angles of the acoustic receivers from the wind angle reference line. The method further includes determining one or more of true airspeed and relative wind angle of the airflow about the exterior of the vehicle based on the planar components of the velocity of the airflow about the exterior of the vehicle, and outputting the one or more of the true airspeed and the relative wind angle for operational control of the vehicle.

### BRIEF DESCRIPTION OF THE DRAWINGS

FIG. 1 is a top-down view of an acoustic air data sensing system disclosed herein; and.

FIG. 2 is a schematic block diagram illustrating further details of the acoustic air data sensing system to produce air data outputs.

### DETAILED DESCRIPTION

As described herein, an acoustic air data sensing system includes acoustic receivers that are located at various known distances and angles from an acoustic transmitter. The acoustic transmitter produces an acoustic signal that is influenced by airflow about the exterior of a vehicle as the signal propagates to the acoustic receivers. The effects of sound propagation speed between the transmitter and the receivers is separated from airflow velocity based on measured times of flight of the acoustic signal and the known distances and angles between the transmitter and each of the acoustic receivers. Accordingly, the determined airflow velocity information is used to generate air data parameters (e.g., true airspeed, relative wind angle, Mach number, and static air temperature) as well as a direct measurement of the speed of sound through the airflow about the vehicle exterior. As such, an acoustic air data sensor implementing techniques of this disclosure can effectively produce air data parameters that are usable for operational control of the vehicle without requiring direct pressure measurements or angular rotation of a vane within the oncoming airflow.

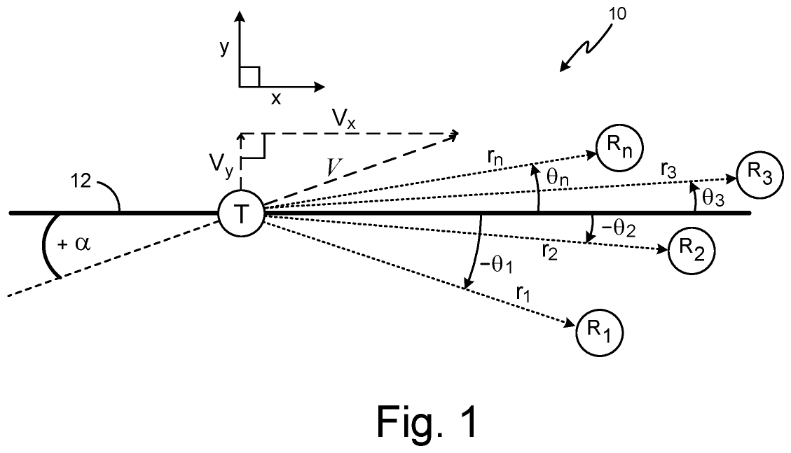

FIG. 1 is a top-down view of acoustic air data sensing system 10 including acoustic transmitter T and acoustic receivers R₁, R₂, R₃, and Rₙ. Acoustic air data sensing system 10 can be mounted on and/or otherwise incorporated into an exterior of a vehicle, such that an acoustic signal transmitted by transmitter T is influenced by airflow over the exterior of the vehicle during propagation of the acoustic signal between transmitter T and each of receivers R₁, R₂, R₃, and Rₙ. While the examples provided herein are described with respect to acoustic air data sensing system 10 mounted on or otherwise incorporated into an aircraft, it should be understood that the techniques of this disclosure are applicable to any vehicle for which air data parameters are to be generated for, e.g., operational control of the vehicle. Examples of such vehicles to which acoustic air data sensing system 10 can be mounted on and/or incorporated into can include, e.g., air vehicles (e.g., aircraft, unmanned aerial vehicles, rotorcraft, drones, missiles, or other air vehicles), ground vehicles (e.g., automobiles, trains, rocket sleds, or other ground vehicles), or any other vehicle for which air data parameters, such as true airspeed, relative wind angle, Mach number, and static air temperature are to be generated for operational control of the vehicle.

In some examples, acoustic air data sensing system 10 is incorporated into a mounting plate or other structure configured to be flush-mounted with the exterior of the aircraft, such that edges of the mounting plate and the acoustic transmitter and receivers are aligned with (i.e., flush with) the exterior surface of the aircraft. Mounting of acoustic air data sensing system 10 flush with the exterior surface of the aircraft can reduce or eliminate aerodynamic and acoustic effects caused by the interface of the oncoming airflow with the mounting plate or the acoustic transmitter or receivers themselves. In other examples, any one or more of acoustic transmitter T and receivers R₁, R₂, R₃, and Rₙ can be integrated into the exterior of the aircraft skin (e.g., and flush with the aircraft exterior skin) without the use of a mounting plate. In yet other examples, the mounting plate and/or the acoustic transmitter T and receivers R₁, R₂, R₃, and Rₙ of acoustic air data sensing system 10 can be mounted on the exterior of the aircraft such that edges of the mounting plate or any one or more of transmitter T and receivers R₁, R₂, R₃, and Rₙ are not flush with the exterior of the aircraft. In such examples, aerodynamic and/or acoustic effects of the non-flush interface of the mounting plate, transmitter T, and/or receivers R₁, R₂, R₃, and Rₙ can be characterized (e.g., in a wind tunnel) and compensated for during the air data parameter computations.

Acoustic transmitter T can be a piezoelectric speaker, a cone speaker, a micro-electro-mechanical systems (MEMS) speaker, or other electric-to-acoustic transducer. Acoustic receivers R₁, R₂, R₃, and Rₙ can be microphones including MEMS microphones, condenser microphones, or other acoustic-to-electric transducers. While the example of FIG. 1 illustrates four separate receivers (i.e., R₁, R₂, R₃, and Rₙ), it should be understood that the reference “n” represents an arbitrary number, such that acoustic air data sensing system 10 can include any number of acoustic receivers R₁-Rₙ.

As illustrated in FIG. 1, each of acoustic receivers R₁, R₂, R₃, and Rₙ is located at a respective radial distance r₁, r₂, r₃, and rₙ from transmitter T. That is, acoustic receiver R₁ is located at radial distance r₁ from transmitter T, acoustic receiver R₂ is located at radial distance r₂ from transmitter T, acoustic receiver R₃ is located at radial distance r₃ from transmitter T, and acoustic receiver Rₙ is located at radial distance rₙ from transmitter T. The radial distances r₁, r₂, r₃, and rₙ can be the same or different distances.

Each of acoustic receivers R₁, R₂, R₃, and Rₙ is located at a respective angle θ₁, θ₂, θ₃, and θₙ with respect to wind angle reference line 12. That is, acoustic receiver R₁ is located at angle −θ₁ (the negative indicating a directional component with respect to wind angle reference line 12), acoustic receiver R₂ is located at angle −θ₂ with respect to wind angle reference line 12, acoustic receiver R₃ is located at angle θ3 with respect to wind angle reference line 12, and acoustic receiver Rₙ is located at angle θₙ with respect to wind angle reference line 12. In some examples, each of acoustic receivers R₁, R₂, R₃, and Rₙ is located at a different angle with respect to wind angle reference line 12. In other examples, any two or more of acoustic receivers R₁, R₂, R₃, and Rₙ can be located at a same angle, but at different radial distances from transmitter T.

Wind angle reference line 12 is a reference line of the aircraft corresponding to one of an angle of attack and an angle of sideslip of the aircraft upon which acoustic air data sensing system 10 is mounted. For instance, acoustic air data sensing system 10 can be mounted on an aircraft in a location that enables acoustic air data sensing system 10 to measure the relative wind angle corresponding to angle of attack of the aircraft, such as on a side of the aircraft. In such examples, wind angle reference line 12 is a reference line of the aircraft corresponding to aircraft angle of attack, such as a chord of a wing of the aircraft corresponding to a known (i.e., reference) aircraft angle of attack (e.g., zero degrees angle of attack). In other examples, acoustic air data sensing system 10 can be mounted on an aircraft in a location that enables acoustic air data sensing system 10 to measure the relative wind angle corresponding to an angle of sideslip of the aircraft, such as on a top or bottom of the aircraft. In such examples, wind angle reference line 12 is a reference line of the aircraft corresponding to aircraft angle of sideslip, such as a line extending between the nose and the tail of the aircraft corresponding to a known (i.e., reference) aircraft angle of sideslip (e.g., zero degrees angle of sideslip).

In some examples, multiple acoustic air data sensors 10 can be mounted on or otherwise incorporated into the aircraft, such as at multiple orientations and/or locations to provide relative wind angle measurements corresponding to multiple wind angle reference lines 12. For instance, in certain examples, a first acoustic air data sensing system 10 can be mounted on the aircraft in a first location (e.g., a side of the aircraft) that enables the first acoustic air data sensing system 10 to measure the relative wind angle corresponding to angle of attack of the aircraft, and a second acoustic air data sensing system 10 can be mounted on the aircraft in a second location (e.g., a top or bottom of the aircraft) that enables the second acoustic air data sensing system 10 to measure the relative wind angle corresponding to angle of sideslip of the aircraft. Accordingly, such multiple acoustic air data sensors 10 can provide air data parameter measurements corresponding to both angle of attack and angle of sideslip for operational control of the aircraft.

As illustrated in FIG. 1, each of acoustic receivers R₁, R₂, R₃, and Rₙ can be located downstream (e.g., aft) of acoustic transmitter T, though in other examples, any one or more of acoustic receivers R₁, R₂, R₃, and Rₙ can be located upstream (e.g., forward) of acoustic transmitter T. Locating receivers R₁, R₂, R₃, and Rₙ downstream of transmitter T, rather than upstream of transmitter T, can help to mitigate airflow boundary layer velocity effects that bend sound waves traveling upstream in the airflow in a direction that is away from the exterior surface of the aircraft (i.e., the mounting surface of acoustic air data sensing system 10). Such bending (i.e., away from the aircraft skin) can attenuate the acoustic signal at the upstream receivers, thereby decreasing the signal-to-noise ratio at the upstream receivers and causing decreased accuracy of air data parameter computations that are based on the acoustic signal received at the upstream receivers. The same airflow boundary layer velocity effects, however, also cause bending of sound waves traveling downstream in the airflow in a direction that is toward the exterior surface of the aircraft. Such bending (i.e., toward the aircraft skin) can increase the strength of the acoustic signal received at the downstream receivers, thereby increasing the signal-to-noise ratio at the downstream receivers. Accordingly, in certain examples, such as the example of FIG. 1, each of the receivers R₁, R₂, R₃, and Rₙ can be located downstream (i.e., aft) of transmitter T to alleviate the shadowing effect (i.e., signal attenuation) at upstream receivers that is exacerbated with greater air velocities.

In addition, as illustrated in FIG. 1, receivers R₁, R₂, R₃, and Rₙ can be located such that no two of acoustic receivers R₁, R₂, R₃, and Rₙ are directly opposing receivers. That is, receivers R₁, R₂, R₃, and Rₙ can be located such that no straight line can be drawn through any two of receivers R₁, R₂, R₃, and Rₙ and transmitter T, with transmitter T located between the two receivers R₁, R₂, R₃, and Rₙ.

In operation, acoustic air data sensing system 10 experiences airflow as it passes over the aircraft exterior, which is illustrated in the example of FIG. 1 as airflow velocity vector V. The direction of travel of airflow velocity vector V forms relative wind angle α with respect to wind angle reference line 12. The magnitude of airflow velocity vector V represents the speed of the airflow (or true airspeed) of the airflow about the aircraft exterior.

Acoustic transmitter T emits an acoustic signal into the airflow about the aircraft exterior. The acoustic signal, affected by the airflow velocity vector V, propagates to each of acoustic receivers R₁, R₂, R₃, and Rₙ, which receive the acoustic signal at varying times. As is further described below, acoustic air data sensing system 10 includes control circuitry that determines times of flight of the emitted acoustic signal to each of receivers R₁, R₂, R₃, and Rₙ based on the time at which the acoustic signal is transmitted from acoustic transmitter T and the various times at which the acoustic signal is received at the receivers R₁, R₂, R₃, and Rₙ The control circuitry determines signal velocities of the acoustic signal to each of the receivers R₁, R₂, R₃, and Rₙ based on the times of flight and the known distances r₁, r₂, r₃, and rₙ between acoustic transmitter T and the acoustic receivers R₁, R₂, R₃, and Rₙ.

Using the determined signal velocities and the known angles θ₁, θ₂, θ₃, and θₙ of the respective acoustic receivers R₁, R₂, R₃, and Rₙ, the control circuitry determines planar components Vₓ, and V_{y} of the airflow velocity vector V, as well as the speed of sound in the airflow (i.e., a direct measurement of the speed of sound in the air about the aircraft exterior). Planar components Vₓ and V_{y} represent the component vectors of airflow velocity vector V in each of the directions defined by perpendicular unit vectors x and y defining a planar coordinate axis. The direction of unit vector x, as illustrated in FIG. 1, is parallel with wind angle reference line 12. The direction of unit vector y is perpendicular to the wind angle reference line 12 (and hence the unit vector x).

As is further described below, acoustic air data sensing system 10 determines air data parameter outputs, including one or more of true airspeed (TAS) of the airflow and the relative wind angle of the airflow (i.e., α) based on the planar components Vₓ and V_{y} of the airflow velocity vector V. Acoustic air data sensing system 10 can further determine air data parameter outputs including a Mach number of the airflow and a static air temperature (SAT) of the airflow based on the planar components Vₓ and V_{y} and the measured speed of sound in the airflow. The air data parameter outputs are transmitted to one or more consuming systems, such as an aircraft flight management system (FMS), autoflight control system (AFCS), electronic flight instrument system (EFIS), or other consuming systems, which use the received air data parameter outputs for operational control of the aircraft.

Accordingly, acoustic air data sensing system 10, implementing techniques of this disclosure, determines aircraft air data parameters, such as TAS, Mach number, angle of attack and/or angle of sideslip, and SAT, based on propagation of an emitted acoustic signal that is received at acoustic receivers R₁, R₂, R₃, and Rₙ The acoustic receivers R₁, R₂, R₃, and Rₙ, in some examples, are each located aft of transmitter T, thereby enabling accurate measurements and air data parameter calculations even at relatively high wind velocities, such as velocities above Mach 0.2. The acoustic air data sensing system 10 described herein can therefore provide air data parameter outputs that are usable for operational control of the aircraft and which are determined based on measurements that may be less susceptible to common failure modes of traditional pneumatic and rotating vane sensors, such as ice accumulation and/or the buildup of particulates such as volcanic ash.

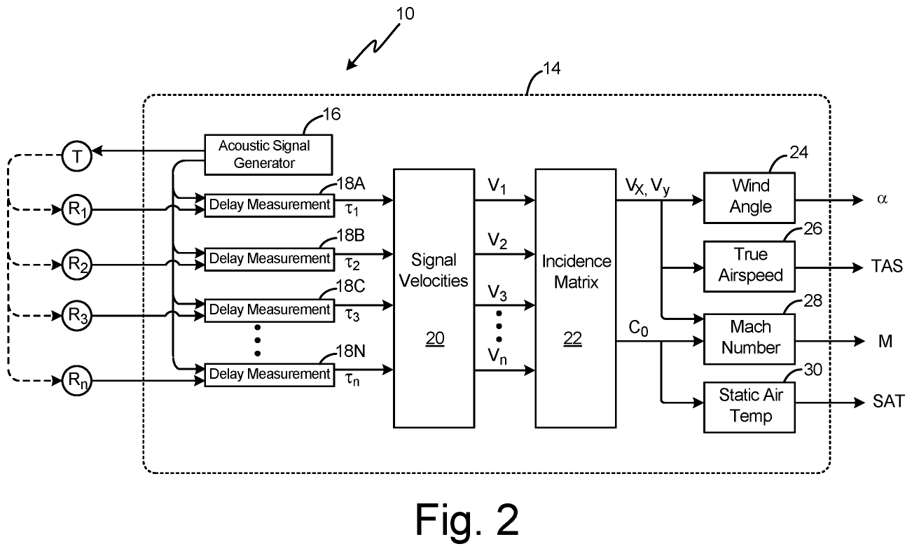

FIG. 2 is a schematic block diagram illustrating further details of acoustic air data sensing system 10 to produce air data outputs. As illustrated in FIG. 2, acoustic air data sensing system 10 further includes control circuitry 14. Control circuitry 14 includes acoustic signal generator 16, delay measurement circuitry 18A-18N, signal velocity circuitry 20, incidence matrix circuitry 22, wind angle circuitry 24, true airspeed circuitry 26, Mach number circuitry 28, and static air temperature circuitry 30.

While the example of FIG. 2 illustrates and describes control circuitry 14 as including various circuit components, it should be understood that in some examples, control circuitry 14 and/or any one or more components of control circuitry 14 can be implemented in hardware, software, or combinations of hardware and software. For instance, control circuitry 14 can take the form of and/or include one or more processors and computer-readable memory encoded with instructions that, when executed by the one or more processors, cause acoustic air data sensing system 10 to operate in accordance with techniques described herein.

Examples of the one or more processors can include any one or more of a microprocessor, a digital signal processor (DSP), an application specific integrated circuit (ASIC), a field-programmable gate array (FPGA), or other equivalent discrete or integrated logic circuitry. Computer-readable memory of control circuitry 14 can be configured to store information within control circuitry 14 during operation. The computer-readable memory can be described, in some examples, as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). Computer-readable memory of control circuitry 14 can include volatile and non-volatile memories. Examples of volatile memories can include random access memories (RAM), dynamic random access memories (DRAM), static random access memories (SRAM), and other forms of volatile memories. Examples of non-volatile memories can include magnetic hard discs, optical discs, floppy discs, flash memories, or forms of electrically programmable memories (EPROM) or electrically erasable and programmable (EEPROM) memories.

As illustrated in FIG. 2, acoustic signal generator 16 provides an electrical control signal to transmitter T representing a waveform of an acoustic signal to be transmitted by transmitter T. Acoustic signal generator 16 also provides the electrical signal representing the waveform of the acoustic signal to be transmitted as a reference signal to delay measurement circuitry 18A-18N. The waveform can take the form of an acoustic pulse, an oscillating acoustic signal, a broadband acoustic signal, a random source acoustic signal, or other form of acoustic signal.

Transmitter T, in response to receiving the electrical control signal from acoustic signal generator 16, transmits the acoustic signal into the airflow about the aircraft exterior. The acoustic signal propagates through the airflow about the aircraft exterior and is received by each of acoustic receivers R₁, R₂, R₃, and Rₙ, as is schematically illustrated by dashed lines in the example of FIG. 2.

Acoustic receivers R₁, R₂, R₃, and Rₙ receive the acoustic signal at varying times. Each of receivers R₁, R₂, R₃, and Rₙ provides an electrical signal to a corresponding one of delay measurement circuitry 18A-18N, the electrical signal representing the waveform of the received acoustic signal. Each of delay measurement circuitry 18A-18N determines the time delay representing the time of flight of the acoustic signal emitted by transmitter T to the respective one of receivers R₁, R₂, R₃, and Rₙ, and outputs the respective time delay to signal velocities circuitry 20. For instance, as illustrated in FIG. 2, delay measurement circuitry 18A outputs time of flight (or time delay) τ₁ to signal velocities circuitry 20, the time of flight τ₁ representing the time of flight of the acoustic signal from transmitter T to acoustic receiver R₁. Delay measurement circuitry 18B outputs time of flight τ₂ to signal velocities circuitry 20, the time of flight τ₂ representing the time of flight of the acoustic signal from transmitter T to acoustic receiver R₂. Delay measurement circuitry 18C outputs time of flight τ₃ to signal velocities circuitry 20, the time of flight τ₃ representing the time of flight of the acoustic signal from transmitter T to acoustic receiver R₃. Delay measurement circuitry 18N outputs time of flight τₙ to signal velocities circuitry 20, the time of flight τₙ representing the time of flight of the acoustic signal from transmitter T to acoustic receiver Rₙ.

Delay measurement circuitry 18A-18N can determine the times of flight τ₁, τ₂, τ₃, and τₙ as the difference in time between the reference signal received from acoustic signal generator 16 and the receiver signal received from a respective one of acoustic receivers R₁, R₂, R₃, and Rₙ, such as a difference in time between time-valued locations of one or more identified features of the signals, such as one or more of a maximum, a minimum, a zero-crossing, or other identified features. In some examples, each of delay measurement circuitry 18A-18N determines the time of flight using cross-correlation operations to determine a correlation signal between the reference signal received from acoustic signal generator 16 and the receiver signal received from the corresponding one of receivers R₁, R₂, R₃, and Rₙ. In such examples, delay measurement circuitry 18A-18N can identify the respective time of flight as the time shift corresponding to a maximum of the correlation signal generated by the cross-correlation operations.

In some examples, delay measurement circuitry 18A-18N determines that a receiver signal from the corresponding one of receivers R₁, R₂, R₃, and Rₙ is not received or is otherwise unsuitable for use with the air data parameter output computations, such as when a failure mode of one of receivers R₁, R₂, R₃, and Rₙ prevents the corresponding receiver from receiving the acoustic signal emitted by transmitter T, or when an acoustic noise burst or other acoustic signal interferes with the acoustic signal emitted by transmitter T. For instance, delay measurement circuitry 18A-18N can determine that the receiver signal is not received or is otherwise unusable in response to determining that a time delay between the receiver signal and the reference signal is greater than (or equal to) a threshold time delay and/or a maximum of the correlation signal between the receiver signal and the reference signal is less than (or equal to) a threshold correlation value. In such examples, delay measurement circuitry 18A-18N can output, as the corresponding one of time of flight τ₁, τ₂, τ₃, and τₙ, a value of zero or other defined value indicating that the receiver signal was not received or is otherwise unusable for air data output computations.

As illustrated in FIG. 2, signal velocities circuitry 20 receives times of flight τ₁-τₙ, from delay measurement circuitry 18A-18N. Signal velocities circuitry 20 determines signal velocities of the acoustic signal from transmitter T to each of acoustic receivers R₁-Rₙ based on the received times of flight τ₁-τₙ and the known distances r₁-rₙ (FIG. 1) between acoustic transmitter T and each of acoustic receivers R₁-Rₙ. For instance, signal velocities circuitry 20 can divide the respective distances r₁-rₙ by the respective times of flight τ₁-τₙ to determine pulse velocities V₁-Vₙ. For instance, signal velocities circuitry 20 can divide distance r₁ by time of flight τ₁ to determine signal velocity V₁ of the acoustic signal between transmitter T and acoustic receiver R₁. Signal velocities circuitry 20 can divide distance r₂ by time of flight τ₂ to determine signal velocity V₂ of the acoustic signal between transmitter T and acoustic receiver R₂. Signal velocities circuitry 20 can divide distance r₃ by time of flight τ₃ to determine signal velocity V₃ of the acoustic signal between transmitter T and acoustic receiver R₃. Signal velocities circuitry 20 can divide distance rₙ by time of flight τₙ to determine signal velocity Vₙ of the acoustic signal between transmitter T and acoustic receiver Rₙ.

In response to determining that any one or more of times of flight τ₁-τₙ has a value of zero or other defined value indicating that the receiver signal from a corresponding one of receivers R₁-Rₙ is not received or is otherwise unsuitable for use with the air data parameter output computations, signal velocities circuitry 20 can output a value of zero or other defined value for the corresponding one of signal velocities V₁-Vₙ indicating that the corresponding receiver signal was not received or is otherwise unsuitable for use with the air data parameter output computations.

Incidence matrix circuitry 22 receives signal velocities V₁-Vₙ from signal velocities circuitry 20. Incidence matrix circuitry 22 determines planar components Vₓ and V_{y} of the airflow velocity vector V (FIG. 1) about the exterior of the aircraft and a speed of sound in the air about the aircraft exterior based on the received signal velocities V₁-Vₙ and the known angles of acoustic receivers R₁-Rₙ from acoustic transmitter T.

For instance, a measured time of flight τⱼ of an acoustic signal from an acoustic transmitter to an acoustic receiver Rⱼ can be expressed according to the following equation:

$${τ}_{j} = \frac{{r}_{j}}{{C}_{0} + V cos ( α - {θ}_{j} )} \qquad ( Equation 1 )$$

where τⱼ is the measured time of flight, rⱼ is the radial distance between the acoustic transmitter and the acoustic receiver Rⱼ, C₀ is the speed of sound, V is the airflow velocity, α is the relative wind angle, and θⱼ is the angle between the acoustic transmitter and the acoustic receiver Rj with respect to a reference wind angle line.

For each measured time of flight τⱼ, the signal velocity Vj to each receiver Rj can therefore be expressed according to the following equation:

$${V}_{j} = \frac{{r}_{j}}{{τ}_{j}} = {C}_{0} + V cos ( α - {θ}_{j} ) \qquad ( Equation 2 )$$

In terms of planar component Vₓ and V_{y} of the airflow velocity vector V, the signal velocities of Equation 2 above can be expressed according to the following equation:

Vⱼ=cos θⱼVₓ+sin θⱼV_{y}+C₀ (Equation 3)

Incidence matrix circuitry 22 can determine planar components Vₓ and V_{y} of airflow velocity vector V as well as speed of sound C₀ using received signal velocities V₁-Vₙ and an incidence matrix M based on the following equation:

$$[ \begin{matrix}{V}_{1} \\ {V}_{2} \\ {V}_{3} \\ ⋮ \\ {V}_{n}\end{matrix} ] = M [ \begin{matrix}{V}_{x} \\ {V}_{y} \\ {C}_{0}\end{matrix} ] \qquad ( Equation 4 )$$

where M is an incidence matrix expressed as:

$$[ \begin{matrix}cos {θ}_{1} & sin {θ}_{1} & 1 \\ cos {θ}_{2} & sin {θ}_{2} & 1 \\ cos {θ}_{3} & sin {θ}_{3} & 1 \\ ⋮ & ⋮ & ⋮ \\ cos {θ}_{n} & sin {θ}_{n} & 1\end{matrix} ]$$

where θ₁ is the angle between acoustic receiver R₁ and wind angle reference line 12, θ₂ is the angle between acoustic receiver R₂ and wind angle reference line 12, θ₃ is the angle between acoustic receiver R₃ and wind angle reference line 12, and θₙ is the angle between acoustic receiver Rₙ and wind angle reference line 12.

In some examples, incidence matrix circuitry 22 can include in the incidence matrix M only those angles corresponding to signal velocities V₁-Vₙ that do not have a value indicating that a corresponding receiver signal was not received or is otherwise unsuitable for the air data parameter output computations. For instance, in response to determining that signal velocity V1 has a value of zero (or other predefined value), incidence matrix circuitry 22 can exclude angle θ₁ (i.e., the first row) from incidence matrix M in Equation 4 above.

Incidence matrix circuitry 22 can therefore determine the values of planar components Vₓ and V_{y} as well as speed of sound C₀ according to the following equation:

$$[ \begin{matrix}{V}_{x} \\ {V}_{y} \\ {C}_{0}\end{matrix} ] = {M}^{+} [ \begin{matrix}{V}_{1} \\ {V}_{2} \\ {V}_{3} \\ ⋮ \\ {V}_{n}\end{matrix} ] \qquad ( Equation 5 )$$

where M⁺ is a pseudo-inverse of the incidence matrix M from Equation 4 above. Incidence matrix circuitry 22 can determine pseudo-inverse M⁺ as, e.g., a Moore-Penrose pseudo-inverse.

Incidence matrix circuitry 22, as illustrated in FIG. 2, provides planar components Vₓ and V_{y} to wind angle circuitry 24, true airspeed circuitry 26, and Mach number circuitry 28. Incidence matrix circuitry 22 provides speed of sound C₀ to Mach number circuitry 28 and static air temperature circuitry 30.

Wind angle circuitry 24 determines relative wind angle α, which can correspond to an angle of attack or angle of sideslip of the aircraft. Wind angle circuitry 24 can determine relative wind angle α according to the following equation:

$$α = {tan}^{- 1} \frac{{V}_{y}}{{V}_{x}} \qquad ( Equation 6 )$$

True airspeed circuitry 26 determines true airspeed TAS of the airflow about the aircraft exterior according to the following equation:

TAS=\sqrt{Vₓ²+V_{y}²} (Equation 7)

Mach number circuitry 28 determines Mach number M according to the following equation:

$$M = \frac{\sqrt{{V}_{x}^{2} + {V}_{y}^{2}}}{{C}_{0}} \qquad ( Equation 8 )$$

Static air temperature circuitry 30 determines static air temperature SAT according to the following equation:

SAT=(kC₀)² (Equation 9)

where k is the constant 38.96695 knots/\sqrt{° K}.

Control circuitry 14, as illustrated in FIG. 2, outputs relative wind angle α, true airspeed TAS, Mach number M, and static air temperature SAT to one or more consuming systems, such as an aircraft flight management system (FMS), autoflight control system (AFCS), electronic flight instrument system (EFIS), or other consuming systems for operational control of the aircraft. Though not illustrated as being output by acoustic air data sensing system 10 in the example of FIG. 2, it should be understood that in some examples, acoustic air data sensing system 10 outputs speed of sound C₀ as an air data parameter output to the one or more consuming systems.

Accordingly, acoustic air data sensing system 10 implementing techniques described herein can determine air data output parameters based on propagation of an emitted acoustic signal to acoustic receivers that can, in some examples, each be located aft of the acoustic transmitter. The techniques of this disclosure can therefore enable accurate acoustic measurements and air data parameter calculations even at relatively high wind velocities, such as velocities above Mach 0.2, thereby enhancing usability of the acoustic air data sensor for providing air data parameters used for controlled flight of the aircraft.

Discussion of Possible Embodiments

The following are non-exclusive descriptions of possible embodiments of the present invention.

An acoustic air data sensing system includes an acoustic transmitter, a plurality of acoustic receivers, and control circuitry. The acoustic transmitter is located to transmit an acoustic signal into airflow about an exterior of a vehicle. Each of the plurality of acoustic receivers is located at a respective angle from a wind angle reference line and a respective distance from the acoustic transmitter to receive the acoustic signal transmitted by the acoustic transmitter. The control circuitry is configured to determine respective times of flight of the acoustic signal from the acoustic transmitter to each of the plurality of acoustic receivers, and determine signal velocities of the acoustic signal to each of the plurality of acoustic receivers based on the respective distances and respective times of flight of the acoustic signal from the acoustic transmitter to the acoustic receivers. The control circuitry is further configured to determine planar components of a velocity of the airflow about the exterior of the vehicle based on the signal velocities and the respective angles of the acoustic receivers from the wind angle reference line, and to determine a speed of sound in the airflow about the exterior of the vehicle based on the signal velocities and the respective angles of the acoustic receivers from the wind angle reference line. The control circuitry is further configured to determine one or more of true airspeed and relative wind angle of the airflow about the exterior of the vehicle based on the planar components of the velocity of the airflow about the exterior of the vehicle, and output the one or more of the true airspeed and the relative wind angle for operational control of the vehicle.

The acoustic air data sensing system of the preceding paragraph can optionally include, additionally and/or alternatively, any one or more of the following features, configurations, operations, and/or additional components:

The control circuitry can be configured to divide the respective distances by the respective times of flight to determine the signal velocities of the acoustic signal to each of the plurality of acoustic receivers.

The control circuitry can be configured to determine the planar components of the velocity of the airflow about the exterior of the vehicle and the speed of sound in the airflow about the exterior of the vehicle using an incidence matrix that is based on the respective angles of the acoustic receivers from the wind angle reference line.

The incidence matrix can take the form of:

$$[ \begin{matrix}cos {θ}_{1} & sin {θ}_{1} & 1 \\ ⋮ & ⋮ & ⋮ \\ cos {θ}_{n} & sin {θ}_{n} & 1\end{matrix} ]$$

where θ₁ is the angle between the wind angle reference line and a first of the plurality of acoustic receivers, and θₙ is the angle between the wind angle reference line and an n^{th} of the plurality of acoustic receivers.

The control circuitry can be configured to determine the planar components of the airflow about the exterior of the vehicle and the speed of sound in the airflow about the exterior of the vehicle using the incidence matrix according to the following equation:

$$[ \begin{matrix}{V}_{x} \\ {V}_{y} \\ {C}_{0}\end{matrix} ] = {M}^{+} [ \begin{matrix}{V}_{1} \\ ⋮ \\ {V}_{n}\end{matrix} ]$$

where Vₓ is the planar component of the airflow about the exterior of the vehicle in a direction that is parallel to the wind angle reference line of the vehicle, V_{y} is the planar component of the airflow about the exterior of the vehicle in a direction that is perpendicular to the wind angle reference line of the vehicle, C₀ is the speed of sound in the airflow about the exterior of the vehicle, M⁺ is a Moore-Penrose pseudo-inverse of the incidence matrix, V₁ is the signal velocity of the acoustic signal to the first of the plurality of acoustic receivers, and Vₙ is the signal velocity of the acoustic signal to the nth of the plurality of acoustic receivers.

The control circuitry can be configured to determine the true airspeed of the airflow about the exterior of the vehicle based on the planar components of the velocity of the airflow about the exterior of the vehicle according to the following equation:

TAS=\sqrt{Vₓ²+V_{y}²}

where TAS is the true airspeed of the airflow about the exterior of the vehicle, Vₓ is the planar component of the airflow about the exterior of the vehicle in a direction that is parallel to the wind angle reference line of the vehicle, and V_{y} is the planar component of the airflow about the exterior of the vehicle in a direction that is perpendicular to the wind angle reference line of the vehicle.

The control circuitry can be configured to determine a Mach number of the airflow about the exterior of the vehicle based on the planar components of the velocity of the airflow about the exterior of the vehicle and the speed of sound in the airflow about the exterior of the vehicle according to the following equation:

$$M = \frac{\sqrt{{V}_{x}^{2} + {V}_{y}^{2}}}{{C}_{0}}$$

where M is the Mach number of the airflow about the exterior of the vehicle, Vₓ is the planar component of the airflow about the exterior of the vehicle in a direction that is parallel to the wind angle reference line of the vehicle, and V_{y} is the planar component of the airflow about the exterior of the vehicle in a direction that is perpendicular to the wind angle reference line of the vehicle.

The control circuitry can be configured to determine the relative wind angle of the airflow about the exterior of the vehicle based on the planar components of the velocity of the airflow about the exterior of the vehicle according to the following equation:

$$α = {tan}^{- 1} \frac{{V}_{y}}{{V}_{x}}$$

where α is the relative wind angle of the airflow about the exterior of the vehicle, Vₓ is the planar component of the airflow about the exterior of the vehicle in a direction that is parallel to the wind angle reference line of the vehicle, and V_{y} is the planar component of the airflow about the exterior of the vehicle in a direction that is perpendicular to the wind angle reference line of the vehicle.

The control circuitry can be configured to determine static air temperature of the airflow about the exterior of the vehicle based on the speed of sound in the air about the exterior of the vehicle according to the following equation:

SAT=(kC₀)²

where SAT is the static air temperature of the airflow about the exterior of the vehicle, C₀ is the speed of sound in the airflow about the exterior of the vehicle, and k is the constant 38.96695 knots/\sqrt{° K}.

Each of the plurality of acoustic receivers can be located downstream of the acoustic transmitter.

The vehicle can be an aircraft.

A method includes transmitting, by an acoustic transmitter of an acoustic air data sensing system located on a vehicle, an acoustic signal into airflow about an exterior of the vehicle. The method further includes receiving the acoustic signal at a plurality of acoustic receivers of the acoustic air data sensor. Each of the plurality of acoustic receivers is located at a respective angle from a wind angle reference line and a respective distance from the acoustic transmitter. The method further includes determining respective times of flight of the acoustic signal from the acoustic transmitter to each of the plurality of acoustic receivers, determining signal velocities of the acoustic signal to each of the plurality of acoustic receivers based on the respective distances and respective times of flight of the acoustic signal from the acoustic transmitter to the acoustic receivers, and determining planar components of a velocity of the airflow about the exterior of the vehicle based on the signal velocities and the respective angles of the acoustic receivers from the wind angle reference line. The method further includes determining a speed of sound in the airflow about the exterior of the vehicle based on the signal velocities and the respective angles of the acoustic receivers from the wind angle reference line, determining one or more of true airspeed and relative wind angle of the airflow about the exterior of the vehicle based on the planar components of the velocity of the airflow about the exterior of the vehicle, and outputting the one or more of the true airspeed and the relative wind angle for operational control of the vehicle.

The method of the preceding paragraph can optionally include, additionally and/or alternatively, any one or more of the following features, configurations, operations, and/or additional components:

Determining signal velocities of the acoustic signal to each of the plurality of acoustic receivers can include dividing the respective distances by the respective times of flight to determine the signal velocities of the acoustic signal to each of the plurality of acoustic receivers.

Determining the planar components of the velocity of the airflow about the exterior of the vehicle and the speed of sound in the airflow about the exterior of the vehicle can include determining the planar components and the speed of sound using an incidence matrix that is based on the respective angles of the acoustic receivers from the wind angle reference line.

The incidence matrix can take the form of:

$$[ \begin{matrix}cos {θ}_{1} & sin {θ}_{1} & 1 \\ ⋮ & ⋮ & ⋮ \\ cos {θ}_{n} & sin {θ}_{n} & 1\end{matrix} ]$$

where θ₁ is the angle between the wind angle reference line and a first of the plurality of acoustic receivers, and θₙ is the angle between the wind angle reference line and an n^{th} of the plurality of acoustic receivers.

Determining the planar components of the airflow about the exterior of the vehicle and the speed of sound in the airflow about the exterior of the vehicle can include determining the planar components and the speed of sound according to the following equation

$$[ \begin{matrix}{V}_{x} \\ {V}_{y} \\ {C}_{0}\end{matrix} ] = {M}^{+} [ \begin{matrix}{V}_{1} \\ ⋮ \\ {V}_{n}\end{matrix} ]$$

where Vₓ is the planar component of the airflow about the exterior of the vehicle in a direction that is parallel to the wind angle reference line of the vehicle, V_{y} is the planar component of the airflow about the exterior of the vehicle in a direction that is perpendicular to the wind angle reference line of the vehicle, C₀ is the speed of sound in the airflow about the exterior of the vehicle, M⁺ is a Moore-Penrose pseudo-inverse of the incidence matrix, V₁ is the signal velocity of the acoustic signal to the first of the plurality of acoustic receivers, and Vₙ is the signal velocity of the acoustic signal to the nth of the plurality of acoustic receivers.

Determining the true airspeed of the airflow about the exterior of the vehicle based on the planar components of the velocity of the airflow about the exterior of the vehicle can include determining the true airspeed according to the following equation:

$$T A S = \sqrt{{V}_{x}^{2} + {V}_{y}^{2}}$$

where TAS is the true airspeed of the airflow about the exterior of the vehicle, Vₓ is the planar component of the airflow about the exterior of the vehicle in a direction that is parallel to the wind angle reference line of the vehicle, and V_{y} is the planar component of the airflow about the exterior of the vehicle in a direction that is perpendicular to the wind angle reference line of the vehicle.

The method can further include determining a Mach number of the airflow about the exterior of the vehicle based on the planar components of the velocity of the airflow about the exterior of the vehicle and the speed of sound in the airflow about the exterior of the vehicle according to the following equation:

$$M = \frac{\sqrt{{V}_{x}^{2} + {V}_{y}^{2}}}{{C}_{0}}$$

where M is the Mach number of the airflow about the exterior of the vehicle, Vₓ is the planar component of the airflow about the exterior of the vehicle in a direction that is parallel to the wind angle reference line of the vehicle, and V_{y} is the planar component of the airflow about the exterior of the vehicle in a direction that is perpendicular to the wind angle reference line of the vehicle.

Determining the relative wind angle of the airflow about the exterior of the vehicle based on the planar components of the velocity of the airflow about the exterior of the vehicle can include determining the relative wind angle according to the following equation:

$$α = {tan}^{- 1} \frac{{V}_{y}}{{V}_{x}}$$

where α is the relative wind angle of the airflow about the exterior of the vehicle, Vₓ is the planar component of the airflow about the exterior of the vehicle in a direction that is parallel to the wind angle reference line of the vehicle, and V_{y} is the planar component of the airflow about the exterior of the vehicle in a direction that is perpendicular to the wind angle reference line of the vehicle.

The method can further include determining static air temperature of the airflow about the exterior of the vehicle based on the speed of sound in the air about the exterior of the vehicle according to the following equation:

SAT=(kC₀)²

where SAT is the static air temperature of the airflow about the exterior of the vehicle, C₀ is the speed of sound in the airflow about the exterior of the vehicle, and k is the constant 38.96695 knots/\sqrt{° K}.

Each of the plurality of acoustic receivers can be located downstream of the acoustic transmitter.

The vehicle can be an aircraft.

A method includes transmitting, by an acoustic transmitter located on a vehicle, an acoustic signal into airflow about an exterior of the vehicle, and receiving the acoustic signal at a plurality of acoustic receivers. Each of the plurality of acoustic receivers can be located at a respective angle from a wind angle reference line of the vehicle and at a respective distance from the acoustic transmitter. The method further includes determining at least one of true airspeed, relative wind angle, Mach number, static air temperature, and a speed of sound through the airflow without directly measuring pressure or angle of rotation of a vane within the airflow or requiring directly opposing locations of any two of the acoustic receivers.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An acoustic air data sensing system comprising:
an acoustic transmitter located to transmit an acoustic signal into airflow about an exterior of a vehicle;
a plurality of acoustic receivers, each of the plurality of acoustic receivers located at a respective angle from a wind angle reference line and a respective distance from the acoustic transmitter to receive the acoustic signal transmitted by the acoustic transmitter; and
control circuitry configured to:
determine respective times of flight of the acoustic signal from the acoustic transmitter to each of the plurality of acoustic receivers;
determine signal velocities of the acoustic signal to each of the plurality of acoustic receivers based on the respective distances and respective times of flight of the acoustic signal from the acoustic transmitter to the acoustic receivers;
determine planar components of a velocity of the airflow about the exterior of the vehicle based on the signal velocities and the respective angles of the acoustic receivers from the wind angle reference line
determine a speed of sound in the airflow about the exterior of the vehicle based on the signal velocities and the respective angles of the acoustic receivers from the wind angle reference line;
determine one or more of true airspeed and relative wind angle of the airflow about the exterior of the vehicle based on the planar components of the velocity of the airflow about the exterior of the vehicle; and
output the one or more of the true airspeed and the relative wind angle for operational control of the vehicle.

2. The acoustic air data sensor of claim 1,
wherein the control circuitry is configured to determine the planar components of the velocity of the airflow about the exterior of the vehicle and the speed of sound in the airflow about the exterior of the vehicle using an incidence matrix that is based on the respective angles of the acoustic receivers from the wind angle reference line.

3. The acoustic air data sensor of claim 2,
wherein the incidence matrix takes the form of:
$$[ \begin{matrix}cos {θ}_{1} & sin {θ}_{1} & 1 \\ ⋮ & ⋮ & ⋮ \\ cos {θ}_{n} & sin {θ}_{n} & 1\end{matrix} ]$$
wherein θ₁ is the angle between the wind angle reference line and a first of the plurality of acoustic receivers, and
wherein θₙ is the angle between the wind angle reference line and an n^{th} of the plurality of acoustic receivers.

4. The acoustic air data sensor of claim 3,
wherein the control circuitry is configured to determine the planar components of the airflow about the exterior of the vehicle and the speed of sound in the airflow about the exterior of the vehicle using the incidence matrix according to the following equation:
$$[ \begin{matrix}{V}_{x} \\ {V}_{y} \\ {C}_{0}\end{matrix} ] = {M}^{+} [ \begin{matrix}{V}_{1} \\ ⋮ \\ {V}_{n}\end{matrix} ]$$
wherein Vₓ is the planar component of the airflow about the exterior of the vehicle in a direction that is parallel to the wind angle reference line of the vehicle;
wherein V_{y} is the planar component of the airflow about the exterior of the vehicle in a direction that is perpendicular to the wind angle reference line of the vehicle;
wherein C₀ is the speed of sound in the airflow about the exterior of the vehicle;
wherein M⁺ is a Moore-Penrose pseudo-inverse of the incidence matrix; and
wherein V₁ is the signal velocity of the acoustic signal to the first of the plurality of acoustic receivers; and
wherein Vₙ is the signal velocity of the acoustic signal to the nth of the plurality of acoustic receivers.

5. The acoustic air data sensor of claim 1,
wherein the control circuitry is configured to determine the true airspeed of the airflow about the exterior of the vehicle based on the planar components of the velocity of the airflow about the exterior of the vehicle according to the following equation:
TAS=\sqrt{Vₓ²+V_{y}²}
wherein TAS is the true airspeed of the airflow about the exterior of the vehicle;
wherein Vₓ is the planar component of the airflow about the exterior of the vehicle in a direction that is parallel to the wind angle reference line of the vehicle; and
wherein V_{y} is the planar component of the airflow about the exterior of the vehicle in a direction that is perpendicular to the wind angle reference line of the vehicle.

6. The acoustic air data sensor of claim 1,
wherein the control circuitry is configured to determine a Mach number of the airflow about the exterior of the vehicle based on the planar components of the velocity of the airflow about the exterior of the vehicle and the speed of sound in the airflow about the exterior of the vehicle according to the following equation:
$$M = \frac{\sqrt{{V}_{x}^{2} + {V}_{y}^{2}}}{{C}_{0}}$$
wherein M is the Mach number of the airflow about the exterior of the vehicle;
wherein Vₓ is the planar component of the airflow about the exterior of the vehicle in a direction that is parallel to the wind angle reference line of the vehicle; and
wherein V_{y} is the planar component of the airflow about the exterior of the vehicle in a direction that is perpendicular to the wind angle reference line of the vehicle.

7. The acoustic air data sensor of claim 1,
wherein the control circuitry is configured to determine the relative wind angle of the airflow about the exterior of the vehicle based on the planar components of the velocity of the airflow about the exterior of the vehicle according to the following equation:
$$α = {tan}^{- 1} \frac{{V}_{y}}{{V}_{x}}$$
wherein α is the relative wind angle of the airflow about the exterior of the vehicle;
wherein Vₓ is the planar component of the airflow about the exterior of the vehicle in a direction that is parallel to the wind angle reference line of the vehicle; and
wherein V_{y} is the planar component of the airflow about the exterior of the vehicle in a direction that is perpendicular to the wind angle reference line of the vehicle.

8. The acoustic air data sensor of claim 1,
wherein the control circuitry is configured to determine static air temperature of the airflow about the exterior of the vehicle based on the speed of sound in the air about the exterior of the vehicle according to the following equation:
SAT=(kC₀)²
wherein SAT is the static air temperature of the airflow about the exterior of the vehicle;
wherein C₀ is the speed of sound in the airflow about the exterior of the vehicle; and
wherein k is the constant 38.96695 knots/\sqrt{° K}.

9. The acoustic air data sensor of claim 1,
wherein each of the plurality of acoustic receivers is located downstream of the acoustic transmitter.

10. The acoustic air data sensor of claim 1,
wherein the vehicle is an aircraft.

11. A method comprising:
transmitting, by an acoustic transmitter of an acoustic air data sensing system located on an vehicle, an acoustic signal into airflow about an exterior of the vehicle;
receiving the acoustic signal at a plurality of acoustic receivers of the acoustic air data sensor, each of the plurality of acoustic receivers located at a respective angle from a wind angle reference line and a respective distance from the acoustic transmitter;
determining respective times of flight of the acoustic signal from the acoustic transmitter to each of the plurality of acoustic receivers;
determining signal velocities of the acoustic signal to each of the plurality of acoustic receivers based on the respective distances and respective times of flight of the acoustic signal from the acoustic transmitter to the acoustic receivers;
determining planar components of a velocity of the airflow about the exterior of the vehicle and a speed of sound in the airflow about the exterior of the vehicle based on the signal velocities and the respective angles of the acoustic receivers from the acoustic transmitter;
determining one or more of true airspeed and relative wind angle of the airflow about the exterior of the vehicle based on the planar components of the velocity of the airflow about the exterior of the vehicle; and
outputting the one or more of the true airspeed and the relative wind angle for operational control of the vehicle.

12. The method of claim 11,
wherein determining the planar components of the velocity of the airflow about the exterior of the vehicle and the speed of sound in the airflow about the exterior of the vehicle comprises determining the planar components and the speed of sound using an incidence matrix that is based on the respective angles of the acoustic receivers from the acoustic transmitter.

13. The method of claim 12,
wherein the incidence matrix takes the form of:
$$[ \begin{matrix}cos {θ}_{1} & sin {θ}_{1} & 1 \\ ⋮ & ⋮ & ⋮ \\ cos {θ}_{n} & sin {θ}_{n} & 1\end{matrix} ]$$
wherein θ₁ is the angle between the wind angle reference line and a first of the plurality of acoustic receivers, and
wherein θₙ is the angle between the wind angle reference line and an n^{th} of the plurality of acoustic receivers.

14. The method of claim 13,
wherein determining the planar components of the airflow about the exterior of the vehicle and the speed of sound in the airflow about the exterior of the vehicle comprises determining the planar components and the speed of sound according to the following equation:
$$[ \begin{matrix}{V}_{x} \\ {V}_{y} \\ {C}_{0}\end{matrix} ] = {M}^{+} [ \begin{matrix}{V}_{1} \\ ⋮ \\ {V}_{n}\end{matrix} ]$$
wherein Vₓ is the planar component of the airflow about the exterior of the vehicle in a direction that is parallel to the wind angle reference line of the vehicle;
wherein V_{y} is the planar component of the airflow about the exterior of the vehicle in a direction that is perpendicular to the wind angle reference line of the vehicle;
wherein C₀ is the speed of sound in the airflow about the exterior of the vehicle;
wherein M⁺ is a Moore-Penrose pseudo-inverse of the incidence matrix; and
wherein V₁ is the signal velocity of the acoustic signal to the first of the plurality of acoustic receivers; and
wherein Vₙ is the signal velocity of the acoustic signal to the nth of the plurality of acoustic receivers.

15. The method of claim 11,
wherein determining the true airspeed of the airflow about the exterior of the vehicle based on the planar components of the velocity of the airflow about the exterior of the vehicle comprises determining the true airspeed according to the following equation:
TAS=\sqrt{Vₓ²+V_{y}²}
wherein TAS is the true airspeed of the airflow about the exterior of the vehicle;
wherein Vₓ is the planar component of the airflow about the exterior of the vehicle in a direction that is parallel to the wind angle reference line of the vehicle; and
wherein V_{y} is the planar component of the airflow about the exterior of the vehicle in a direction that is perpendicular to the wind angle reference line of the vehicle.

16. The method of claim 11, further comprising:
determining a Mach number of the airflow about the exterior of the vehicle based on the planar components of the velocity of the airflow about the exterior of the vehicle and the speed of sound in the airflow about the exterior of the vehicle according to the following equation:
$$M = \frac{\sqrt{{V}_{x}^{2} + {V}_{y}^{2}}}{{C}_{0}}$$
wherein M is the Mach number of the airflow about the exterior of the vehicle;
wherein Vₓ is the planar component of the airflow about the exterior of the vehicle in a direction that is parallel to the wind angle reference line of the vehicle; and
wherein V_{y} is the planar component of the airflow about the exterior of the vehicle in a direction that is perpendicular to the wind angle reference line of the vehicle.

17. The method of claim 11,
wherein determining the relative wind angle of the airflow about the exterior of the vehicle based on the planar components of the velocity of the airflow about the exterior of the vehicle comprises determining the relative wind angle according to the following equation:
$$α = {tan}^{- 1} \frac{{V}_{y}}{{V}_{x}}$$
wherein α is the relative wind angle of the airflow about the exterior of the vehicle;
wherein Vₓ is the planar component of the airflow about the exterior of the vehicle in a direction that is parallel to the wind angle reference line of the vehicle; and
wherein V_{y} is the planar component of the airflow about the exterior of the vehicle in a direction that is perpendicular to the wind angle reference line of the vehicle.

18. The method of claim 11, further comprising:
determining static air temperature of the airflow about the exterior of the vehicle based on the speed of sound in the air about the exterior of the vehicle according to the following equation:
SAT=(kC₀)²
wherein SAT is the static air temperature of the airflow about the exterior of the vehicle;
wherein C₀ is the speed of sound in the airflow about the exterior of the vehicle; and
wherein k is the constant 38.96695 knots/\sqrt{° K}.

19. The method of claim 11,
wherein each of the plurality of acoustic receivers is located downstream of the acoustic transmitter.

20. A method comprising:
transmitting, by an acoustic transmitter located on a vehicle, an acoustic signal into airflow about an exterior of the vehicle;
receiving the acoustic signal at a plurality of acoustic receivers, each of the plurality of acoustic receivers located at a respective angle from a wind angle reference line of the vehicle and at a respective distance from the acoustic transmitter; and
determining at least one of true airspeed, relative wind angle, Mach number, static air temperature, and a speed of sound through the airflow without directly measuring pressure or angle of rotation of a vane within the airflow or requiring directly opposing locations of any two of the acoustic receivers.
